(19) United States
(12) Patent Application Publication
(10) Pub. No.: US 2007/0087155 A1
(43) Pub. Date: Apr. 19, 2007

(54) Optical information recording medium

(75) Inventors: Eiji Kariyada, Tokyo (JP); Shuichi Ohkubo, Tokyo (JP)

Correspondence Address: DICKSTEIN SHAPIRO LLP, 1177 AVENUE OF THE AMERICAS (6TH AVENUE), NEW YORK, NY, 10036-2714, US

(73) Assignee: NEC Corporation, Tokyo (JP)

(21) Appl. No.: 11/549,348

(22) Filed: Oct. 13, 2006

(30) Foreign Application Priority Data
Oct. 13, 2005 (JP) 2005-298462

(51) Int. Cl. B32B 3/02

(52) U.S. Cl. 428/64.4

(57) ABSTRACT

An optical disc includes a first information layer and a second information layer, with an optical separation layer between them. The first information layer, provided near the side of the laser beam incident surface, includes at least a first dielectric layer, a recording layer, a second dielectric layer, a metallic translucent layer and a transmittance adjustment layer, laminated in this order. The first dielectric layer includes sulfide, but the second dielectric layer does not include sulfide. The refractive index of the second dielectric layer is same as or larger than that of the first dielectric layer.

### BACKGROUND OF THE INVENTION

1. Field of the Invention

The present invention relates to an optical information recording medium in which information is written or read out by irradiating a laser beam. In particular, the present invention relates to an optical information recording medium in which information is read out from or written onto a plurality of recording layers by irradiating a laser beam from the same incident surface.

2. Description of Related Art

An optical information reading/writing method using a laser beam is capable of accessing a medium by a head in a non-contacting manner at a high speed to thereby read or write information of large capacity from/onto the medium. Therefore, such a medium is practically used in various fields as a large-capacity memory. Optical information recording media using an optical information reading/writing method are known as CD (compact discs) and LD (laser discs), which are categorized as: read-only type that users are only allowed to read data; writable type that users can write new data on the media; and rewritable type that users can write and erase data repeatedly to rewrite data. Optical information recording media of writable and rewritable types are used as external memories of computers and as media for storing document files and image files.

Rewritable optical information recording media include phase-change optical discs utilizing phase changes in recording films and magneto-optical discs utilizing changes in the magnetizing direction of perpendicular magnetization films. As for phase-change optical discs, information can be written without external magnetic fields not like optical magnetic discs. Further, since overwriting of information is easy, phase-change optical discs are becoming the mainstream of rewritable optical information recording media currently.

In recent years, in order to improve the recording capacity of optical information recording media, developments have been performed actively in such fields as land/groove recording in which recording is performed in both guide grooves for tracking and parts between the guide grooves in a substrate, density growth in which a signal processing technique is added to the land/groove recording, and super resolution in which minute marks smaller than the optical diffraction limit can be reproduced. Among these techniques, a multi-layer medium in which a plurality of record layers are provided while a laser beam is made incident on the same surface, in particular, a double-layer optical information recording media using two recording layers, enables to greatly increase the recording capacity. Therefore, various manufacturers are developing such medium energetically. Currently, as record-type DVD media using red semiconductor laser, discs of 4.7 GB with single layer, and 9 GB with two layers have already been marketed.

Similarly, even for optical information recording media using blue-violet semiconductor laser, it is also indispensable to increase the recording capacity to be larger. As a means therefor, double-layer optical information recording medium using two recording layers has been researched and developed energetically. Such a medium is so configured that a first information layer and a second information layer are included with an optical separation layer between them. As the first information layer provided near a laser beam incident surface, a configuration in which a first dielectric layer, a recording layer, a second dielectric layer and a metallic translucent layer are laminated sequentially, or a configuration in which a dielectric layer is provided above a metallic translucent layer in order to improve the transmittance of the first information layer, has been known. The dielectric layer in the latter configuration is for enhancing the transmittance of the first information layer as much as possible in order to perform stable read/write operation to the second information layer. As a target of the transmittance, a recording film of the first information layer requires the sum of the transmittance Ta in an amorphous state and the transmittance Tc in a crystal state to be not less than 85%, and the larger value is better.

Further, as the first dielectric layer and the second dielectric layer, ZnS-SiO₂ is used generally. As the metallic translucent layer, a thin film of Ag alloy mainly made of Ag is used generally. By laminating the Ag alloy thin film to be thin of about 10 nm thickness, it has been known that the transmittance of the first information layer becomes about 40 to 50% for a wavelength of blue-violet laser(near 400 nm). Since no other metal has been known which becomes translucent in the wavelength field currently, Ag alloy thin film is an indispensable material as a metallic translucent layer of a medium having multi-layered information recording layer.

Patent Document 1: Japanese Patent Laid-Open Publication No. 2002-144736

However, the conventional art described above involves the following problems.

As an example of a double-layered optical information recording medium developed conventionally, there is such a film configuration that on a transparent substrate, a first information layer is provided in which a first lower-side protective layer, an interface layer, a recording layer, an interface layer, a first upper-side protective layer, a barrier layer, a metallic translucent layer, a barrier layer and a transmittance adjustment layer are laminated in this order, and on the first information layer, a second information layer is provided via an optical separation layer. Further, ZnS-SiO₂ is used for the first lower-side protective layer and the first upper side protective layer, and a metallic translucent film of Ag series is used as the metallic translucent layer because of the reasons described above. As the transmittance adjustment layer, ZnS-SiO₂ same as the first lower-side protective layer and the first upper-side protective layer or TiO₂ is used.

Note that in the above-described medium, the barrier layer interposed between the first upper-side protective layer and the metallic translucent layer is provided to protect Ag, which is the main component of the metallic translucent layer, from being sulfurated by S component included in the first upper-side protective layer. Similarly, the barrier layer interposed between the metallic translucent layer and the transmittance adjustment layer is provided to prevent sulfuration of Ag if the transmittance adjustment layer is ZnS-SiO₂, and to prevent movement of elements included in the respective layers between the transmittance adjustment layer and the metallic translucent layer due to temperature rise by the laser beam at the time of reading and writing if the transmittance adjustment layer is TiO₂.

As described above, if the main component of the metallic translucent layer is Ag, when a protective film made of ZnS-SiO₂ is provided thereon and therebelow, interface layers of any kind are required in order to prevent sulfuration of Ag. Therefore, the number of layers in the first information layer increases, which has caused such problems that the manufacturing cost increases and the quality management becomes complicated. Further, if TiO₂ is used for the transmittance adjustment layer, there has been such a problem that the film formation speed is extremely low, which is not suitable for the productivity.

### SUMMARY OF THE INVENTION

It is therefore the main object of the present invention to provide an optical information recording medium capable of preventing sulfuration of a metallic translucent layer with a simple configuration.

The present invention is an optical information recording medium configured to include a plurality of information layers laminated in which information is capable of being written or read out by irradiating a laser beam. At least one of the plural information layers is a metallic translucent layer which transmits the laser beam at a constant rate from the information layer to another information layer. The composition of the metallic translucent layer includes silver, and the composition of a layer adjacent to the metallic translucent layer does not include sulfur. Therefore, the metallic translucent layer will not be sulfurated without a barrier layer adjacent thereto. The present invention can also be configured as follows.

The optical information recording medium may be so configured as to include a first information layer and a second information layer in which information can be written or read out by irradiating a laser beam, and an optical separation layer interposed between the first information layer and the second information layer, which are laminated. The first information layer is provided on a side to which the laser beam is irradiated, and includes at least a first dielectric layer, a recording layer, a second dielectric layer, a metallic translucent layer and a transmittance adjustment layer, laminated in this order from the side to which the laser beam is irradiated. The composition of the metallic translucent layer includes silver, and the composition of the first dielectric layer includes sulfur, but the composition of the second dielectric layer does not include sulfur. The refractive index of the second dielectric layer is same as or larger than the refractive index of the first dielectric layer. In other words, the optical information recording medium includes the first information layer and the second information layer with the optical separation layer between them, and the first information layer provided near the side of a laser beam incident surface includes at least the first dielectric layer, the recording layer, the second dielectric layer, the metallic translucent layer and the transmittance adjustment layer, laminated in this order. The first dielectric layer includes sulfide, but the second dielectric layer does not include sulfide. Further, the refractive index of the second dielectric layer is same as or larger than that of the first dielectric layer.

Since an Ag alloy thin film is indispensable as the metallic translucent layer, if the second dielectric layer is formed by using the same material as a ZnS-SiO₂ film used as the first dielectric layer, the Ag alloy thin film will be sulfurated due to the reason described above. In order to prevent this problem, the second dielectric layer is made of a material different from that of the first dielectric layer. Further, by making the refractive index of the second dielectric layer same as or larger than that of the first dielectric layer, it is possible to secure the transmittance sufficient for realizing stable read/write operation to the second information layer.

As described above, the present invention is so configured that in the first information layer, the second dielectric layer does not include sulfide, and further, the refractive index of the second dielectric layer is same as or larger than that of the first dielectric layer. This is intended to provide an optical information recording medium having transmittance sufficient for realizing stable read/write operation to the second information layer with a simple configuration in which a barrier layer between the metallic translucent layer and the second dielectric layer can be omitted.

The optical information recording medium may be characterized in that the refractive indexes of the second dielectric layer and the transmittance adjustment layer are larger than that of the first dielectric layer. This is to increase the transmittance of the first information layer as much as possible in order to realize stable read/write operation to the second information layer, as described above.

The optical information recording medium may be characterized in that the composition of the second dielectric layer and the composition of the transmittance adjustment layer include an oxide or an oxinitride of niobium. In other words, the optical information recording medium may be characterized in that the second dielectric layer and the transmittance adjustment layer are dielectric films consisting of an oxide or an oxinitride, the main component of which is niobium. Further, the optical information recording medium may be characterized in that the compositions of the second dielectric layer and the transmittance adjustment layer include an oxide or an oxinitride of at least one additive element selected from zirconium, tin and titanium. In other words, the optical information recording medium may be characterized in that the second dielectric layer and the transmittance adjustment layer are dielectric layers consisting of an oxide or an oxinitride including at least one additive element selected from zirconium (Zr), tin (Sn) and titanium (Ti). These materials have faster film formation speed compared with a TiO₂ film, and suitable for mass production.

The optical information recording medium may be characterized in that the amount of the additive element included in the second dielectric layer and the transmittance adjustment layer is not more than 16 at % if zirconium or tin is selected, and not more than 55 at % if titanium is selected. This is because the optical characteristics and the target material characteristics held by an Nb-series oxide or an Nb-series oxinitride, mainly made of Nb, will be deteriorated if the amount of additive element is larger than these amounts. The optical information recording medium may be characterized in that a barrier layer is provided between the metallic translucent layer and the transmittance adjustment layer. The barrier layer is provided because of the following reason. That is, after a thin metallic translucent layer of about 10 nm is laminated, a surface of the metallic translucent layer may be altered due to an atmosphere gas when the transmittance adjustment layer is laminated, depending on a film formation device or a film formation process, so the barrier layer is provided to prevent a case where the designed transmittance and reflectance cannot be realized.

The optical information recording medium may be characterized in that the barrier layer has an extinction coefficient in a range of 0 to 0.07 for the laser beam with a wavelength in a range of 380 nm to 430 nm, and is made of an oxide, a nitride or an oxinitride of metal or semimetal in which film formation is possible in an atmosphere of not including an oxide gas. The optical information recording medium may be characterized in that the barrier layer is made of one or more element selected from GeAlN, SiN, SiO₂, Al₂O₃, Ta₂O₅, ZrO, HfO and ZnO, or an oxinitride thereof. In other words, the optical information recording medium is characterized in that the barrier layer has an extinction coefficient in a range of 0 to 0.07 for the laser beam with a wavelength in a range of 380 nm to 430 nm, and is made of an oxide, a nitride or an oxinitride of metal or semimetal in which film formation is possible in an atmosphere of not including an oxide gas. Further, the optical information recording medium may be characterized in that the barrier layer is made of one material selected from GeAlN, SiN, SiO₂, Al₂O₃, Ta₂O₅, ZrO, HfO and ZnO, or an oxinitride thereof. This is because of the following reason. That is, when the transmittance adjustment layer is formed on the metallic translucent layer by reactive sputtering, a surface of the metallic translucent layer may be oxidized by a sputter gas when forming, that is, an oxide gas for example, depending on the film formation device or the film formation process, so the material mentioned above is used to prevent the oxidization. Even if the barrier layer itself includes oxygen or nitrogen, it is combined strongly with an unreactive substance in the film, so it does not affect the metallic translucent layer.

A first effect of the present invention is achieved as follows. That is, in an optical information recording medium including a first information layer provided near the side of a laser beam incident surface and a second information layer provided via an optical separation layer, a material forming a second dielectric layer and a transmittance adjustment layer, provided above and below a metallic translucent layer mainly made of Ag, is different from ZnS-SiO₂ forming a first dielectric layer, whereby it is possible to provide an optical information recording medium having long storage stability in which the number of layers constituting the first information layer is small.

Further, a second effect of the present invention is achieved as follows. That is, by using materials providing the refractive indexes of a second dielectric layer and a transmittance adjustment layer being larger than the refractive index of a first dielectric layer, the transmittance of a first information layer can be kept high as much as possible, so it is possible to provide an optical information recording medium capable of realizing stable read/write operation to a second information layer.

Effect of the Invention

According to the optical information recording medium of the present invention, sulfur is not included in the composition of a layer adjacent to a metallic translucent layer. Therefore, it is possible to prevent sulfuration of the metallic translucent layer with a simple configuration without providing a barrier layer adjacent to the metallic translucent layer.

### BRIEF DESCRIPTION OF THE DRAWINGS

FIG. 1 is a sectional view showing a first embodiment of an optical information recording medium according to the present invention;

FIG. 2 is a sectional view showing a second embodiment of an optical information recording medium according to the present invention;

FIG. 3 is a sectional view showing a first information layer of an optical disc according to an example 3 and a comparative example 1;

FIG. 4 is a graph showing the relationship between the time of sputter etching performed in a state where a shutter is closed and the transmittance after the first information layer is formed; and

FIG. 5 is a sectional view showing a first information layer of an optical disc according to an embodiment 4;

FIG. 6 is a graph showing the relationship between Zr loadings and refractive index of an NbZrOx film; and

FIG. 7 is a graph showing the relationship between Ti content and film formation speed of an NbTiO film.

### DESCRIPTION OF PREFERRED EMBODIMENTS

Hereinafter, embodiments of the present invention will be described specifically with reference to the accompanying drawings. As an embodiment, a rewritable phase-change optical disc is used, which may be used as a DVD (Digital Versatile Disc) for example.

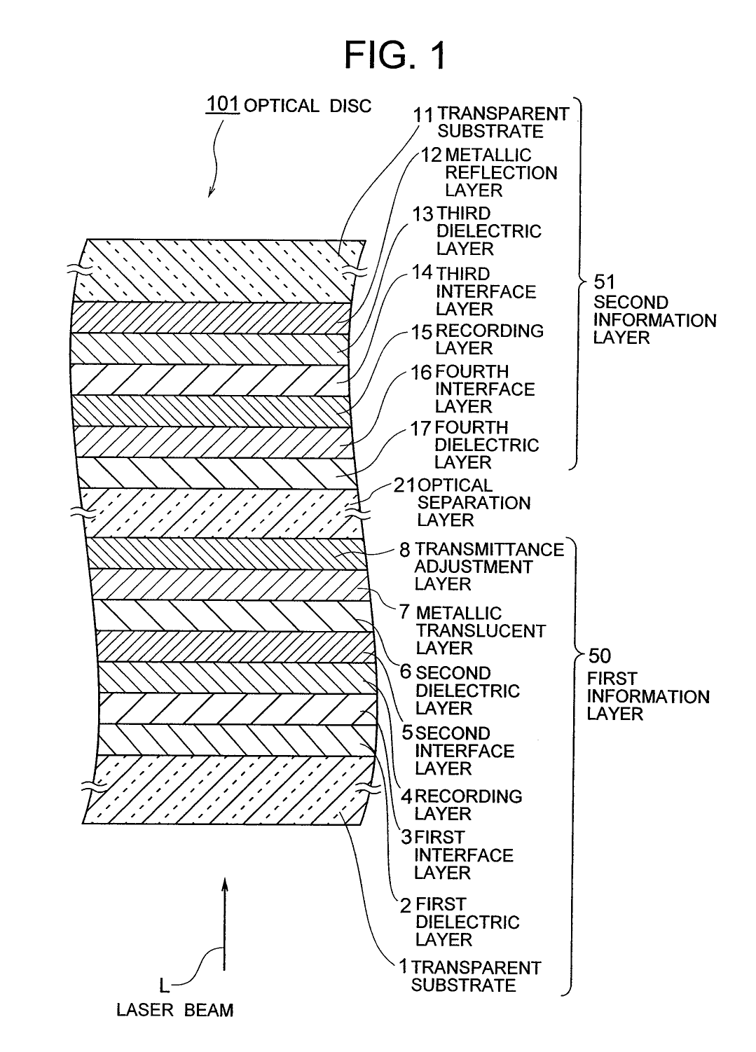

FIG. 1 is a sectional view showing a first embodiment of an optical information recording medium according to the present invention. Hereinafter, description will be made based on FIG. 1.

An optical disc 101 of the present embodiment includes a transparent substrate 1 on which a first dielectric layer 2, a first interface layer 3, a recording layer 4, a second interface layer 5, a second dielectric layer 6, a metallic translucent layer 7 and a transmittance adjustment layer 8 are laminated in this order. They are collectively referred to as a first information layer 50. On the first information layer 50, an optical separation layer 21 is formed, and further, a second information layer 51 is disposed thereon. The second information layer 51 is formed such that on a transparent substrate 11 same as that of the first information layer 50, a metallic reflection layer 12, a third dielectric layer 13, a third interface layer 14, a recording layer 15, a fourth interface layer 16 and a fourth dielectric layer 17 are laminated in this order. The first information layer 50 and the second information layer 51 are laminated on different transparent substrates 1 and 11 respectively, and finally, they are adhered to each other via the optical separation layer 21 made of ultraviolet lay-cured resin, whereby an optical information recording medium having two information layers is fabricated. A laser beam L used for reading and writing information is made incident from the first information layer 50 side.

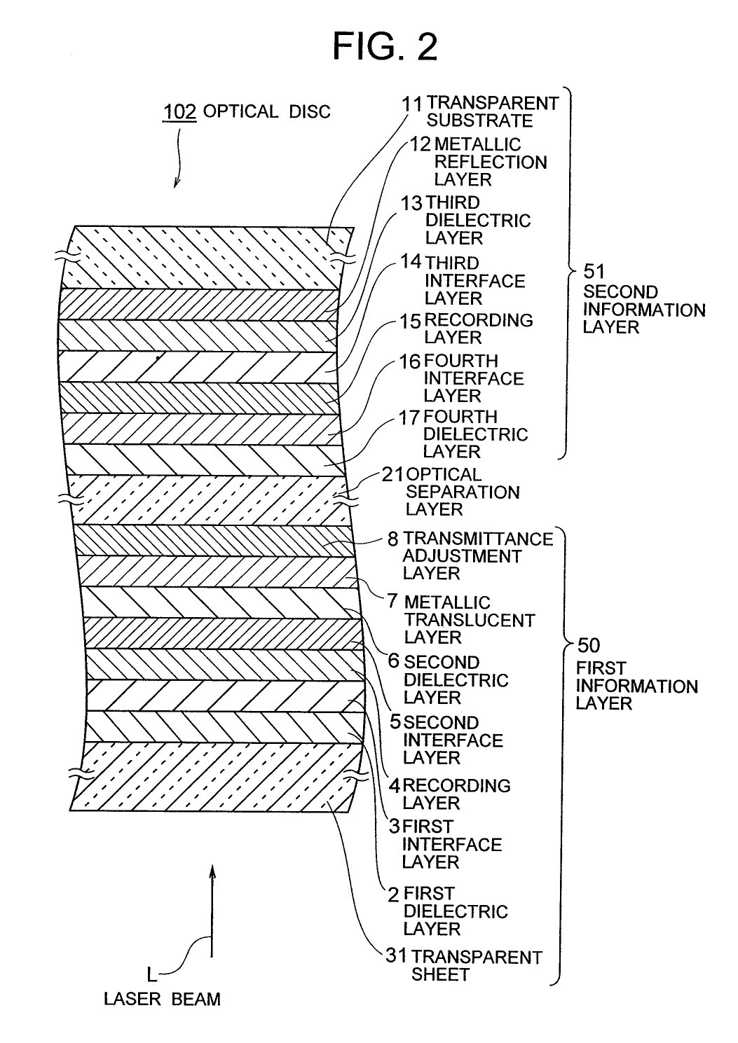

FIG. 2 is a sectional view showing a second embodiment of an optical information recording medium according to the present invention. Hereinafter, description will be made based on FIG. 2.

An optical disc 102 of the present embodiment is so configured that on the transparent substrate 11, the metallic reflection layer 12, the third dielectric layer 13, the third interface layer 14, the recording layer 15, the fourth interface layer 16, and the fourth dielectric layer 17 are laminated in this order, as the second information layer 15. Further, the optical separation layer 21 made of ultraviolet ray-cured resin is formed thereon. At this time, guiding grooves (not shown) consisting of lands and grooves are formed simultaneously on the optical separation layer 21, and on the optical separation layer 21, the transmittance adjustment layer 8, the metallic translucent layer 7, the second dielectric layer 6, the second interface layer 5, the recording layer 4, the first interface layer 3, and the first dielectric layer 2 are laminated in this order as the first information layer 50, and finally, a transparent sheet 31 having a thickness of about 100 μm is attached by using ultraviolet ray-cured resin. The laser beam L used for reading and writing information is made incident from the first information layer 50 side via the thin transparent sheet 31.

In the optical discs 101 and 102, the laser beam L is made incident from the first information layer 50 side, so the laminated order of the first information layer 50 viewed from the laser beam L is same although the fabricating procedures of the respective optical discs are different. Accordingly, the first information layer 50 of the optical disc 101 will be explained more specifically below by way of examples.

### EXAMPLE 1

As shown in FIG. 1, the optical disc 101 includes the transparent substrate 1 on which the first dielectric layer 2 made of ZnS-SiO₂, the first interface layer 3 made of GeN, the recording layer 4 made of GeSbTe, the second interface layer 5 made of GeN, the second dielectric layer 6 made of NbOx, the metallic translucent layer 7 made of AgPdCu, and the transmittance adjustment layer 8 made of NbOx are laminated in this order.

### EXAMPLE 2

The layer configuration is almost same as that of the example 1 mentioned above, but the second dielectric layer 6 and the transmittance adjustment layer 8 are made of NbOxNy.

In the examples 1 and 2, the first information layer 50 was fabricated in which the second dielectric layer 6 and the transmittance adjustment layer 8 were made of various thin film materials. Further, in other examples, NbZrOx, NbZrOxNy, NbSnOx, NbSnOxNy, NbTiOx and NbTiOxNy were used as materials for the second dielectric layer 6 and the transmittance adjustment layer 8, respectively.

### COMPARATIVE EXAMPLE 1

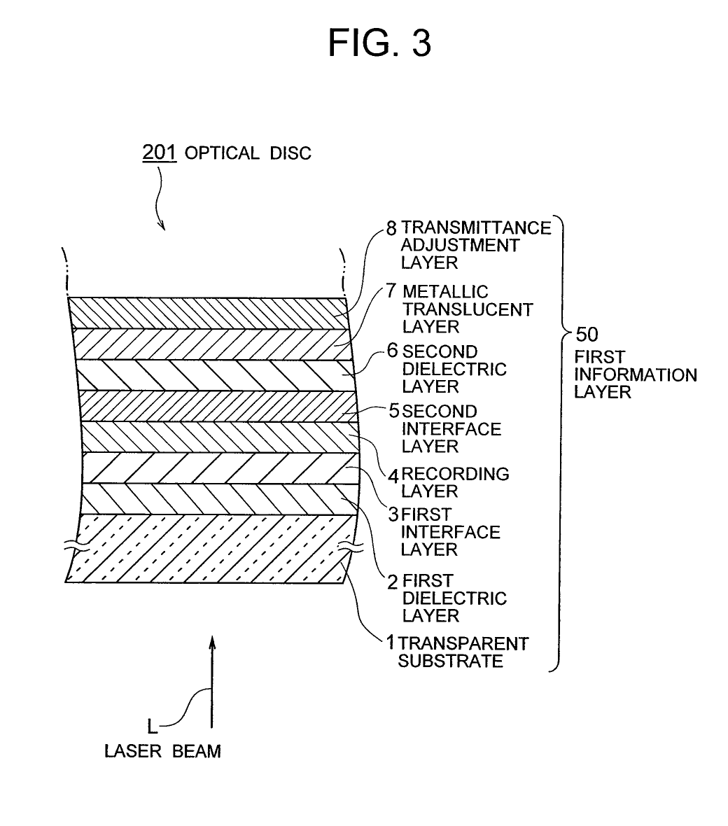

An optical disc 201 (the second information layer 51 is omitted in FIG. 3) of a comparative example 1 as shown in FIG. 3 was fabricated in order to compare characteristics thereof with those of the examples mentioned above. The optical disc 201 includes the transparent substrate 1 on which the first dielectric layer 2 made of ZnS-SiO₂, the first interface layer 3 made of GeN, the recording layer 4 made of GeSbTe, the second interface layer 5 made of GeN, the second dielectric layer 6 made of ZnS-SiO₂, the metallic translucent layer 7 made of AgPdCu, and the transmittance adjustment layer 8 made of ZnS-SiO₂ were laminated in this order.

Next, as another comparative example, an optical disc was fabricated by using SiO₂ as the material of the second dielectric layer 6 and the transmittance adjustment layer 8, and using the same materials for the other layers as used in the comparative example 1.

Note that a film formation device for laminating the first information layer 50 described above is a sheet-type sputtering device in which each material is provided in each sputtering room.

For the examples and the comparative examples, Table 1 shows the relationship between the refractive index and the transmittance of materials of the second dielectric layer 6 and the transmittance adjustment layer 8. Transmittance was measured in the first information layer 50 alone. Further, for optical discs in which the respective materials are used for the second dielectric layer 6 and the transmittance adjustment layer 8, levels of transmittance changes before and after an environmental test is shown. In Table 1, a sign “o” shows no change was made in transmittance before and after the test, and a sign “x” indicates that a change of 5% or more was made. Note that as a transmittance value, the sum of a transmittance Ta of the first information layer 50 where the recording layer 4 of the first information layer 50 was in an amorphous state and a transmittance Tc of the first information layer 50 where the recording layer 4 was in a crystal state was used in this case. All of the refractive indexes and the transmittances are values taken at the wavelength of 405 nm.

TABLE 1
Relationship between refractive index and
transmittance in each optical disc>

| | Second dielectric | | | Transmittance |
|---|---|---|---|---|
| | layer 6 and | | | Change by |
| | Transmit. | Refractive | | Environmental |
| No. | adjustment layer 8 | Index | Transmittance | Test |
| 1 | NbOx | 2.55 | 94.5 | ∘ |
| 2 | NbOxNy | 2.53 | 94.4 | ∘ |
| 3 | NbZrOx | 2.51 | 94.3 | ∘ |
| 4 | NbZrOxNy | 2.49 | 94.3 | ∘ |
| 5 | NbSnOx | 2.54 | 94.5 | ∘ |
| 6 | NbSnOxNy | 2.50 | 94.3 | ∘ |
| 7 | NbTiOx | 2.73 | 96.6 | ∘ |
| 8 | NbTiOxNy | 2.70 | 95.7 | ∘ |
| 9 | ZnS—SiO₂ | 2.35 | 92.1 | x |
| 10 | SiO₂ | 1.58 | 70.6 | ∘ |

Optical discs were fabricated considering the film thickness of each disc such that the reflection rate Ra of the optical disc where the recording layer was in an amorphous state was not more than 6%, the reflection rate Rc of the optical disc where the recording layer was in a crystal state was not less than 10%, and the difference between Rc and Ra (Rc-Ra) was large and the Ta+Tc mentioned above became large. The transmittance shown in Table 1 is a value measured after fabricating the optical disc in such a manner. Further, as described above, the first dielectric layer 2 was formed by using ZnS-SiO₂, and the refractive index of this film was 2.35.

From the results shown in Table 1, it is found that when the refractive index of the second dielectric layer 6 and the transmittance adjustment layer 8 is larger than the refractive index of the first dielectric layer 2 made of ZnS-SiO₂ (No. 1 to 8), the sum of transmittances of the first information layer 50 is in a range of 94.3% to 96.6%. On the other hand, in the case where the refractive index of the second dielectric layer 6 and the transmittance adjustment layer 8 is same as the refractive index of the first dielectric layer 2 made of ZnS-SiO₂ (No. 9), the sum of the transmittances shows a somewhat low value. Further, in the case where the refractive index of the second dielectric layer 6 and the transmittance adjustment layer 8 is smaller than the refractive index of the first dielectric layer 2 (No. 10), the sum of transmittances is 70.6%, which is found to be extremely lower compared with other optical discs.

The optical discs shown in Table 1 were held for 500 hours under a constant temperature and humidity environment of 80° C. and 90% RH, and change levels of the transmittance before and after an environmental test were compared. As a result, only in the case where ZnS-SiO₂ same as the first dielectric layer 2 was used for the second dielectric layer 6 and the transmittance adjustment layer 8 adjacent to the metallic translucent layer 7 (No. 9), it was confirmed that the transmittance changed largely before and after the test. This is due to the fact that the S component included in the second dielectric layer 6 and the transmittance adjustment layer 8 sulfurates Ag which was the main component of the metallic translucent layer 7.

Further, operations to read and write information repeatedly were tried by using the optical discs of No. 1 to 8 having high transmittance and high reliability. As a result, it was confirmed that no change was made in any optical disc by comparing the signal quality after ten-thousand operations with the initial signal quality. From the result, in the case where the transmittance adjustment layer 8 made of the material shown in Table 1 is laminated, it is determined that no mutual movement of materials constituting the thin films was caused between the metallic translucent layer 7 and the transmittance adjustment layer 8.

Accordingly, it is possible to provide an optical disc exhibiting excellent reliability and having transmittance capable of performing read/write operation without causing any problem to the second information layer 51, by using a dielectric layer different from the first dielectric layer 2 (ZnS-SiO₂) for the second dielectric layer 6 and the transmittance adjustment layer 8 adjacent to the metallic translucent layer 7, and by using a material in which the refractive index of the second dielectric layer 6 and the transmittance adjustment layer 8 is larger than the refractive index of the first dielectric layer 2, as described above.

Although description has been given for optical discs in which dielectric layers made of the same material are used as the second dielectric layer 6 and the transmittance adjustment layer 8 in the examples described above, the present invention is not limited to this configuration. In any combination of the dielectric materials shown in No. 1 to 8 of Table 1, it has already been confirmed to be able to provide optical discs exhibiting high reliability and having transmittance in which read/write operation can be performed without causing any problem to the second information layer 51 same as those described above.

Next, an example 3 of the present invention will be described. An optical disc of the present example includes the transparent substrate 1 same as the optical disc 201 as shown in FIG. 3, on which the first dielectric layer 2 made of ZnS-SiO₂, the first interface layer 3 made of GeN, the recording layer 4 made of GeSbTe, the second interface layer 5 made of GeN, the second dielectric layer 6 made of NbTiOxNy, the metallic translucent layer 7 made of AgPdCu, and the transmittance adjustment layer 8 made of NbTiOxNy are laminated in this order.

For film formation of the optical disc, a film formation device of inline type in which a plurality of target materials were arranged in one sputter chamber was used. In this case, an AgPdCu target for forming the metallic translucent layer 7 and an NbTi target for forming the transmittance adjustment layer 8 are arranged in one sputter chamber.

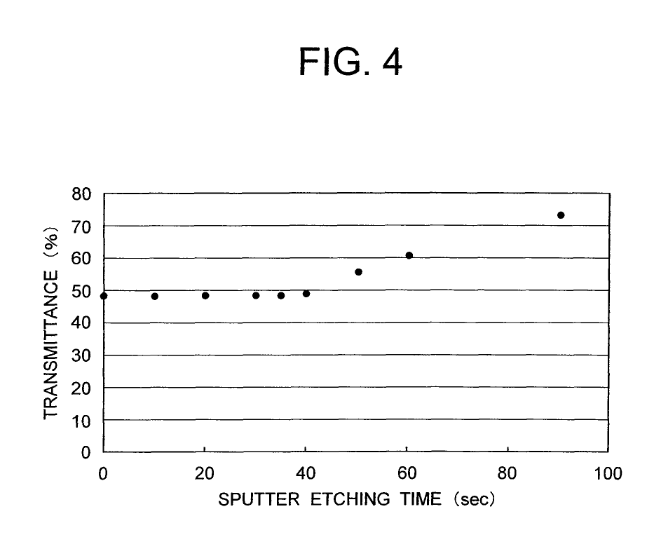

Now, a method of laminating the transmittance adjustment layer 8 made of NbTiOxNy, after laminating the metallic translucent layer 7, will be described. An NbTiOxNy film is formed by using an NbTi target in an atmosphere of Ar, O₂ and N₂ gas. In this case, assuming that the power density is 2.2 W/cm² for example, the film is formed in a mixed gas atmosphere in which O₂ is added by 4% and N₂ is added by 6% to the Ar gas. At this time, in a state where the shutter plate arranged immediately above the target is closed, sputter etching is performed to the NbTi target surface for a certain time period, and then, the NbTiOxNy film is laminated on the AgPdCu. FIG. 4 shows the relationship between the time of sputter etching performed in the state where the shutter plate is closed and the transmittance after the first information layer is formed. Since transmittance after film formation was measured in this case, the recording layer 4 made of GeSbTe is in an amorphous state.

As obvious from FIG. 4, it is found that the transmittance increases gradually when the sputter etching time exceeds 40 seconds. The designed value of the transmittance of this optical disc is 48%, and the measured value in a range where the sputter etching time is short is 48.2%, so a value almost same as the designed value is obtained. However, when the sputter etching time exceeds 40 seconds, the transmittance shows a value different from the designed value. This may be caused by the fact that the metallic translucent layer 7 is oxidized or nitrided if the metallic translucent layer 7 is exposed in the sputter etching atmosphere for forming the NbTiOxNy film thereon for a long time, as described above. Accordingly, in such a case, it is desirable to make the sputter etching time for forming the NbTiOxNy film within 30 seconds or to provide a barrier layer (described later) between the metallic translucent layer 7 and the transmittance adjustment layer 8.

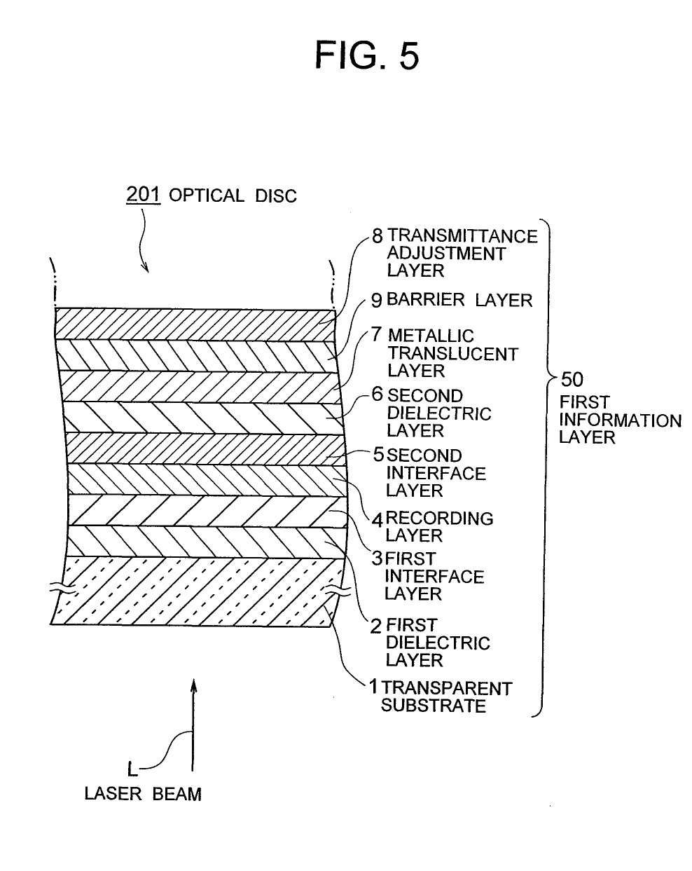

Next, as an example 4 of the present invention, an optical disc having the first information layer 50 in which a barrier layer 9 was laminated between the metallic translucent layer 7 made of AgPdCu and the transmittance adjustment layer 8 made of NbTiOxNy was fabricated, as shown in FIG. 5. Table 2 shows the relationship between the composition of the barrier layer 9 and the target material for forming it and the atmosphere gas, and the transmittance after formation of the first information layer 50 including the barrier layer 9. The transmittance value after film formation in optical disc design is 49%. In this case, an NbTiOxNy film was used as the transmittance adjustment layer 8 to be laminated on the barrier layer 9, and when forming the film, the NbTiOxNy film was formed after performing sputter etching to the NbTi target surface for 60 seconds.

TABLE 2
Relationship between barrier layer and film
formation conditions and transmittance>

| | | Target | Atmosphere | Transmittance |
|---|---|---|---|---|
| No. | Barrier layer | material | gas type | [%] |
| 1 | GeAlN | GeAl | Ar + N₂ | 49.3 |
| 2 | GeAlN | GeAlN | Ar | 49.2 |
| 3 | SiN | Si | Ar + N₂ | 49.1 |
| 4 | SiN | SiN | Ar | 48.9 |
| 5 | SiO₂ | Si | Ar + O₂ | 57.6 |
| 6 | SiO₂ | SiO₂ | Ar | 48.9 |
| 7 | Al₂O₃ | Al | Ar + O₂ | 59.3 |
| 8 | Al₂O₃ | Al₂O₃ | Ar | 49.5 |
| 9 | Ta₂O₅ | Ta | Ar + O₂ | 58.6 |
| 10 | Ta₂O₅ | Ta₂O₅ | Ar | 49.2 |
| 11 | ZrO | Zr | Ar + O₂ | 64.6 |
| 12 | ZrO | ZrO | Ar | 48.7 |
| 13 | HfO | Hf | Ar + O₂ | 63.1 |
| 14 | HfO | HfO | Ar | 49.4 |
| 15 | ZnO | Zn | Ar + O₂ | 58.9 |
| 16 | ZnO | ZnO | Ar | 49.4 |

As obvious from Table 2, in each of the optical discs (No. 5, 7, 9, 11, 13, 15) having the barrier layer 9 formed with an atmosphere gas including an oxygen gas, transmittance after film formation differs from the designed value. On the other hand, in each of the optical discs (No. 1 to 4, 6, 8, 10, 12, 14, 16) having the barrier layer 9 formed with an atmosphere gas not including an oxygen gas, transmittance after film formation is almost same as the designed value. Although transmittances in the case of using oxinitride made of these materials are not shown in Table 2, they have also been confirmed that transmittance same as the design value can be obtained in the case of an atmosphere gas not including an oxygen gas, similarly.

In this way, it was found that if the metallic translucent layer 7 mainly made of Ag was exposed to an oxygen atmosphere to some extent, desired optical disc characteristics might not be obtained since the metallic translucent layer 7 was oxidized. From Table 2, it is found that the metallic translucent layer 7 mainly made of Ag is not affected by a nitride gas included in an atmosphere gas.

Therefore, it is found that in the case where the oxygen gas may affect to some extent when the transmittance adjustment layer 8 is formed, the atmosphere gas for forming the transmittance adjustment layer 8 will not affect by forming the barrier layer 9 consisting of oxide, nitride or oxinitride formed in an atmosphere not including an oxygen gas on the metallic translucent layer 7.

Next, necessity that an extinction coefficient of the barrier layer 9 should fall within a range of 0 to 0.07 in the laser wavelength area of 380 to 430 nm will be described, based on an example 5 of the present invention. An optical disc of the present example has the same configuration as that of FIG. 5, but the material of a dielectric body is slightly different. In this example, an NbTiOx film is used as the second dielectric layer 6 and the transmittance adjustment layer 8, and a GeAlN film is used as the barrier layer 9. In the GeAlN film, the extinction coefficient varies depending on the gas pressure and nitrogen loading at the time of film formation, so it was examined how the transmittance of the first information layer 50 changed if the barrier layer was formed by varying the extinction coefficient of the film. Table 3 shows the relationship between the extinction coefficient of the barrier layer 9 and the transmittance. Note that the design conditions of the optical disc configuration are same as the conditions mentioned in the comparative example 1, and as the transmittance value, the sum of a transmittance Ta when the recording layer was in an amorphous state and a transmittance Tc when the recording layer was in a crystal state was used. Although measurement was performed at the wavelength of 405 nm, it was confirmed that the value would not largely change within the wavelength range mentioned above.

TABLE 3
Relationship between extinction coefficient and
transmittance>

| Extinction coefficient | |
|---|---|
| of barrier layer | transmittance [%] |
| 0 | 96.6 |
| 0.02 | 95.5 |
| 0.04 | 94.2 |
| 0.06 | 92.6 |
| 0.07 | 90.0 |
| 0.08 | 87.6 |
| 0.10 | 85.3 |

From Table 3, it is found that when the extinction coefficient value of the barrier layer 9 exceeds 0.07, the sum of transmittances falls to below 90%, so it is concerned that stable read/write operation may not be performed to the second information layer 51. Therefore, the extinction coefficient value of the barrier layer 9 is desirably within a range of 0 to 0.07. Although description has been given exemplary for the case of extinction coefficient of a GeAlN film here, the same result was obtained for the barrier layer shown in Table 2 and in the case where these films were used for barrier layers.

Next, the reason why materials mainly made of Nb were used for the second dielectric layer 6 and the transmittance adjustment layer 8 will be given below. As described above, although a TiO₂ film is used as the transmittance adjustment layer 8, this is because the refractive index of the film is relatively high. However, for a TiO₂ film, the film formation speed is very slow and has less productivity. For materials mainly made of Nb, the present inventors found out that film formation conditions in which the refractive index was same as that of TiO₂ and the film formation speed was relatively fast. Table 4 shows values in which each film formation speed is standardized by the film formation speed of a TiO₂ film, and the refractive indexes thereof. Note that loading of Zr, Sn or Ti included in each film is 5 at %.

TABLE 4
Comparison of film formation speeds>

| | | Standardized film | Refractive |
|---|---|---|---|
| No. | Film Type | formation speed | index |
| 1 | NbOx | 5.9 | 2.557 |
| 2 | NbOxNy | 5.6 | 2.522 |
| 3 | NbZrOx | 6.2 | 2.513 |
| 4 | NbZrOxNy | 5.4 | 2.505 |
| 5 | NbSnOx | 6.0 | 2.524 |
| 6 | NbSnOxNy | 5.7 | 2.501 |
| 7 | NbTiOx | 5.4 | 2.564 |
| 8 | NbTiOxNy | 5.1 | 2.560 |
| 9 | TiO₂ | 1 | 2.600 |

A TiO₂ film can be formed by a combination of a Ti target and a mixed gas atmosphere of Ar and O₂, or by a combination of a TiOx target and a gas atmosphere of only Ar or a mixed gas atmosphere of Ar and O₂. Similarly, an NbOx film can be formed by a combination of an Nb target and a mixed gas atmosphere of Ar and O₂, or a combination of an NbO target and a gas atmosphere of only Ar or a mixed gas atmosphere of Ar and O₂. A TiO₂ film and an NbOx film can be formed by methods similar to each other as described above. However, in the case of forming a TiO₂ film from a Ti target by reactive sputtering, in order to obtain a film having a small extinction coefficient, it is required to add more oxygen compared with the conditions of forming an NbOx film from an Nb target by reactive sputtering. Therefore, the formation speed of a TiO₂ film becomes slower than the formation speed of an NbOx film. Further, since the TiOx target has lower sputtering rate (not subject to sputtering) than the NbOx target, the film formation speed will not be faster. Further, since the TiOx target is fragile itself, if the input power is increased for making the film formation speed faster, a problem of the target being damaged will be caused. In view of the above, an oxide film, a nitride film and an oxynitride film mainly made of Nb are found as materials in which refractive index thereof is in the same level as that of TiO₂ film and the film formation speed is faster.

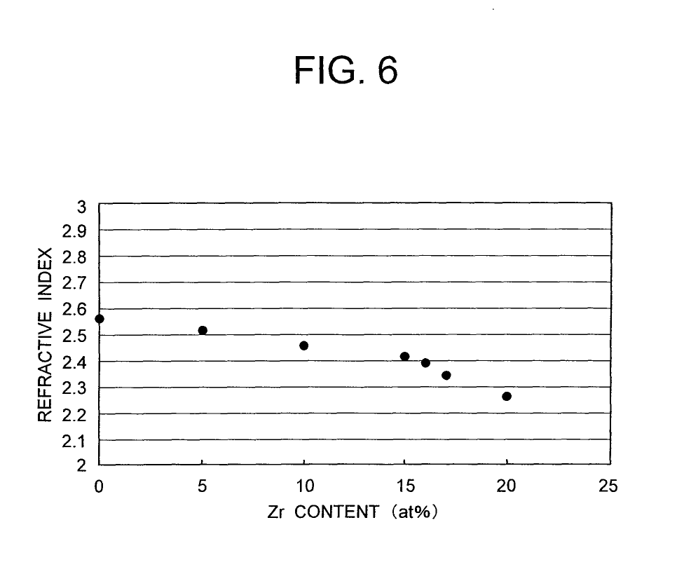

Next, description will be given for the content of additive element in an oxide film and an oxynitride film mainly made of Nb used as the second dielectric layer 6 and the transmittance adjustment layer 8. First, in the case where Zr or Sn is included in an NbOx film, as the content of each element increases, the refractive index of the film drops. The drop level is almost same in any element, and when it exceeds 17 at %, it becomes lower than the refractive index (2.35) of ZnS-SiO₂ generally used in DVD or optical disc. Therefore, as the content of Zr or Sn, not more than 16 at % is preferable. As an example, FIG. 6 shows the relationship between Zr loading and refractive index of an NbZrOx film.

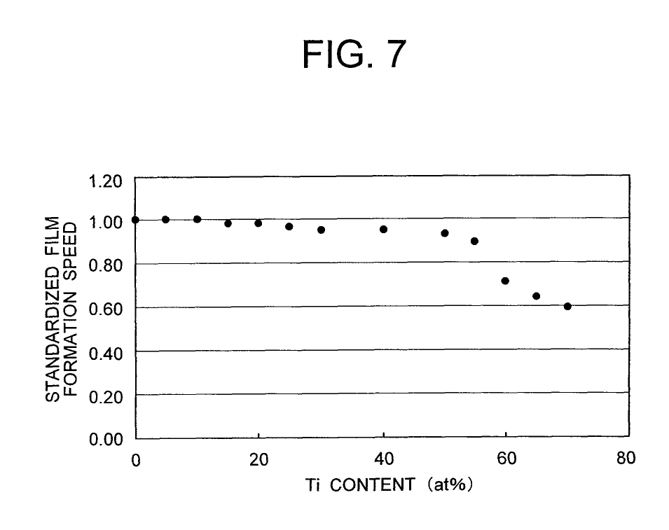

Further, in the case where Ti is included in an NbOx film, the film formation speed of the NbTiOx film drops as the content of Ti increases. FIG. 7 shows the relationship between the Ti content and film formation speed of an NbTiO film. In FIG. 7, it is standardized with the value of NbOx (Ti=0 at %). From FIG. 7, it is found that the film formation speed drops rapidly when the Ti dosing is 60 at % or more.

As described above, it is found that the amount of Zr or Sn included in an NbOx film is desirably not more than 16 at % respectively, and that the amount of Ti included in an NbOx film is desirably not more than 55 at %.

What is claimed is:

1. An optical information recording medium comprising a plurality of information layers laminated in which information is capable of being written or read out by irradiating a laser beam, wherein
at least one of the plurality of information layers is a metallic translucent layer which transmits the laser beam at a constant speed from the information layer to another information layer; and
a composition of the metallic translucent layer includes silver, and a composition of a layer adjacent to the metallic translucent layer does not include sulfur.

2. An optical information recording medium comprising:
a first information layer and a second information layer in which information is capable of being written or read out by irradiating a laser beam; and an optical separation layer positioned between the first information layer and the second information layer, which are laminated, wherein
the first information layer is provided on a side to which the laser beam is irradiated, and includes at least a first dielectric layer, a recording layer, a second dielectric layer, a metallic translucent layer and a transmittance adjustment layer, laminated in this order from the side to which the laser beam is irradiated,
a composition of the metallic translucent layer includes silver, and a composition of the first dielectric layer includes sulfur, but a composition of the second dielectric layer does not include sulfur, and
a refractive index of the second dielectric layer is same as or larger than a refractive index of the first dielectric layer.

3. The optical information recording medium, as claimed in claim 2, wherein the refractive index of the second dielectric layer and a refractive index of the transmittance adjustment layer are larger than the refractive index of the first dielectric layer.

4. The optical information recording medium, as claimed in claim 2, wherein the composition of the second dielectric layer and a composition of the transmittance adjustment layer include an oxide or an oxinitride of niobium.

5. The optical information recording medium, as claimed in claim 4, wherein the composition of the second dielectric layer and the composition of the transmittance adjustment layer include an oxide or an oxinitride of at least one additive element selected from zirconium, tin and titanium.

6. The optical information recording medium, as claimed in claim 5, wherein an amount of the additive element included in the second dielectric layer and the transmittance adjustment layer is not more than 16 at % if zirconium or tin is selected and not more than 55at% if titanium is selected.

7. The optical information recording medium, as claimed in claim 2, wherein a barrier layer is provided between the metallic translucent layer and the transmittance adjustment layer.

8. The optical information recording medium, as claimed in claim 7, wherein the barrier layer has an extinction coefficient in a range of 0 to 0.07 for the laser beam with a wavelength in a range of 380 nm to 430 nm, and is made of an oxide, a nitride or an oxinitride of metal or semimetal in which film formation is possible in an atmosphere of not including an oxide gas.

9. The optical information recording medium, as claimed in claim 8, wherein the barrier layer is made of one or more material selected from GeAlN, SiN, SiO₂, Al₂O₃, Ta₂O₅, ZrO, HfO and ZnO, or an oxinitride thereof.
